(19) United States
(12) Patent Application Publication
(10) Pub. No.: US 2026/0192398 A1
(43) Pub. Date: Jul. 9, 2026

(54) DUAL BEAM LASER DRILLING SYSTEM

(71) Applicant: K2 LASER SYSTEM INC., Anyang-si (KR)

(72) Inventors: Myeong Soo KIM, Anyang-si (KR); Yeoungcheol KIM, Anyang-si (KR); Ko Dong PARK, Anyang-si (KR); Jooho JUNG, Anyang-si (KR); Yi Ho SHIN, Anyang-si (KR)

(21) Appl. No.: 19/251,647

(22) Filed: Jun. 26, 2025

(30) Foreign Application Priority Data
Jan. 6, 2025 (KR) 10-2025-0001525
Jun. 26, 2025 (KR) 10-2025-0084850

(51) Int. Cl. B23K 26/382; B23K 26/06; B23K 26/0622

(52) U.S. Cl. CPC B23K 26/382; B23K 26/0622; B23K 26/0643

(57) ABSTRACT

The present invention relates to a laser drilling system, and aims to provide a dual-beam laser drilling system for high-speed micro drilling. To that end, the present invention discloses a dual-beam laser drilling system comprising a first laser source outputting a first laser pulse; a second laser source outputting a second laser pulse; an optical coupling unit coaxially combining the first laser pulse and the second laser pulse; a scanner for drilling by irradiating the coaxially combined laser beam to a processing target; and a controller controlling the first laser pulse and the second laser pulse in synchronization, wherein the first laser pulse and the second laser pulse have different characteristics from each other.

### CROSS-REFERENCE TO RELATED APPLICATION(S)

This application claims priority to Korean Patent Application Nos. 10-2025-0001525, filed on Jan. 6, 2025, and 10-2025-0084850, filed on Jun. 26, 2025, in the Korean Intellectual Property Office, the disclosures of which are incorporated by reference herein in their entireties.

### TECHNICAL FIELD

The present invention relates to a high-precision micro drilling system, and more particularly, to a dual-beam laser drilling system for synchronizing and coaxially combining a plurality of laser pulses having different wavelengths or pulse widths from each other and performing high-speed precise drilling.

### DISCUSSION OF RELATED ART

A laser pulse is an important technology for high-speed, high-precision processing, and plays an important role particularly in processing that requires thin plate materials or fine patterns. This technology may perform high-speed precise processing mainly on materials such as thin films, metal plates, and ceramics, and is widely used in industries such as semiconductor manufacturing, fuel cell supports, porous metal filters, touch screens, and position sensor substrates.

A laser pulse is a method of performing processing by concentrating energy on a material by emitting periodic energy pulses, enabling high-precision processing while minimizing thermal effects. In particular, laser pulses provide very high precision that may create fine structures and patterns, and may minimize thermal effects that may occur during processing to reduce deformation of materials. This makes it suitable for uniformly processing a plurality of fine holes in metal plates for fuel cell manufacturing, and for substrate processing of other electronic devices and components.

Conventional laser processing technology mainly performs micro processing using nanosecond, picosecond, or femtosecond lasers. A nanosecond laser has moderate energy density and generates pulses at high speed to enable fast processing. However, conventional systems have significantly slow processing speeds due to dependence on mechanical positions such as gantries or linear stages, or in conventional systems, synchronization between laser pulses and scanner movement speed is not perfectly achieved, making it difficult to maintain constant spacing between processing points. This may cause non-uniform pulse distribution and local excessive processing problems caused by acceleration and deceleration.

Technology for supporting high-speed movement of a scanner often failed to achieve smooth high-speed movement due to motor inertia problems. Therefore, additional synchronization technology is essential to accurately control laser pulses while the scanner is moving. If synchronization is not achieved, processing quality deteriorates, and abnormal processing phenomena that may occur at the start and end points of processing lines may occur.

The information disclosed in the background art of the invention is only for enhancing understanding of the background of the present invention, and therefore may include information that does not constitute prior art.

### SUMMARY

An object of the present invention is to provide a dual-beam laser drilling system that synchronizes and coaxially combines a plurality of laser pulses having different wavelengths or pulse widths from each other to perform high-speed precise micro drilling.

Conventional laser drilling systems had limitations in processing quality due to synchronization problems between laser pulses and scanner movement speed that may occur during high-speed processing. In particular, there were problems where pulse distribution became non-uniform in acceleration and deceleration sections of the scanner, or local excessive processing occurred.

Accordingly, the present invention solves the synchronization problem between a high-speed moving scanner and laser pulses so that laser pulses and scanner movement speed exactly match. Accordingly, constant spacing between processing points is maintained, and processing quality may be consistently maintained even in high-speed processing.

Further, the present invention realizes uniform processing by synchronizing control of laser pulses and movement speed of the scanner. This enables high-speed precise drilling while accurately maintaining spacing between fine holes.

Further, the present invention enables an efficient and economical high-speed drilling process based on a system utilizing a plurality of laser pulses having different wavelengths or pulse widths and a steering system such as a scanner, fast steering mirror (FSM), and polygon, without expensive equipment such as ultrashort pulse lasers.

Further, the present invention presents a system that accurately maintains spacing between laser pulses even during high-speed movement of the scanner and prevents non-uniform pulse distribution or excessive processing due to acceleration and deceleration.

A dual-beam laser drilling system according to the present invention includes: a first laser source outputting a first laser pulse; a second laser source outputting a second laser pulse; an optical coupling unit coaxially combining the first laser pulse and the second laser pulse; a scanner for drilling by irradiating the coaxially combined laser beam to a processing target; and a controller controlling the first laser pulse and the second laser pulse in synchronization, wherein the first laser pulse and the second laser pulse have different characteristics from each other.

In one or more embodiments, the first laser pulse and the second laser pulse have different pulse widths from each other, and the controller may control such that each pulse of the first laser pulse is disposed within each pulse width of the second laser pulse.

In one or more embodiments, the first laser pulse and the second laser pulse have different wavelengths from each other but have the same pulse width, and the controller may control such that each pulse of the first laser pulse and the second laser pulse completely matches on the same time axis.

In one or more embodiments, the system further includes a pulse controller adjusting each of on/off gating and timing of the first laser pulse and the second laser pulse, and the pulse controller may control the pulse controller to dispose a plurality of pulses of the first laser pulse within a pulse width of the second laser pulse or dispose them to completely match.

In one or more embodiments, the pulse controller includes a first pulse controller and a second pulse controller adjusting each of on/off gating and timing of the first laser pulse and the second laser pulse under the control of the controller, wherein the first pulse controller and the second pulse controller may include an acousto-optic modulator (AOM) or an electro-optic modulator (EOM) for performing optical modulation.

In one or more embodiments, the scanner includes a Galvano motor, a start position detection sensor, and a polygon mirror, and the start position detection sensor may detect a laser beam reflected from the polygon mirror and detect a start position of the polygon mirror and transmit to the controller.

In one or more embodiments, the controller may include a synchronization monitoring controller for synchronizing timing of the first laser pulse and the second laser pulse with position movement of the scanner in real-time.

In one or more embodiments, the optical coupling unit further includes a deformable mirror for adjusting an overall optical focus of the coaxially combined laser beam, and the controller may control to move an optical Z-axis focus downward stepwise according to drilling processing time or processing depth.

In one or more embodiments, the optical coupling unit further includes a fast steering mirror for high-speed steering of the first laser pulse, and the controller may control the fast steering mirror to correct position deviation due to aberration.

In one or more embodiments, the controller may control the fast steering mirror such that the first laser pulse moves in a specific path within a beam of the second laser pulse.

In one or more embodiments, the controller may control such that a start point of each pulse of the first laser pulse is disposed at a specific point of each pulse of the second laser pulse.

In one or more embodiments, the controller may control such that a plurality of pulses of the first laser pulse are disposed within each pulse width of the second laser pulse.

In one or more embodiments, the controller may control such that an output intensity of the first laser pulse gradually increases during each pulse duration of the second laser pulse.

The present invention provides a dual-beam laser drilling system that enables high-speed, high-precision micro drilling and high-density patterning, through which the following effects may be obtained:

First, the system of the present invention may form perforated holes at uniform spacing even in acceleration and deceleration sections by accurately synchronizing laser pulses and movement speed of the scanner. Accordingly, processing quality is enhanced and spacing between holes is consistently maintained.

Further, the present invention ensures synchronization through a real-time synchronization monitoring unit so that laser pulse spacing and drilling hole spacing exactly match. Accordingly, high precision may be maintained even when processing fine holes.

Further, the present invention may perform continuous drilling operations at high speed by optimizing high-speed movement of the scanner and laser pulse control, greatly enhancing productivity. Irregular processing points or non-uniform hole spacing that may occur in conventional technology may be prevented.

Further, the present invention may realize high-speed, high-precision drilling without using expensive equipment by configuring multiple lasers and a scanner having different characteristics (having different wavelengths or different pulse widths from each other) as a basis. Accordingly, system costs may be decreased and commercialization potential is increased.

Further, the present invention may be applied to various industries such as fuel cell supports, porous metal filters, and electronic device substrate processing. It may be utilized in various fields requiring high-speed, high-precision micro drilling, thereby enhancing efficiency of production processes.

Further, the present invention enables processing optimized for various materials using dual-beam lasers. When using a long wavelength laser and a short wavelength laser simultaneously, or when using a long pulse width laser and a short pulse width laser simultaneously, optimal processing effects may be achieved for various materials such as metals and non-metals respectively. Further, high-speed and high-precision processing is possible. Two laser beams work simultaneously to increase processing speed, while precise control of timing and position of laser beams enables formation of fine holes or patterns. Further, energy efficiency may be maximized. Since lasers of two wavelengths each show high absorption rates for different materials, energy loss may be decreased and processing may be performed more efficiently.

Ultimately, dual-beam lasers provide advantages such as various material processing, precision enhancement, productivity increase, taper reduction, and spatter reduction, making them an advantageous choice for high-speed precision processing operations.

### BRIEF DESCRIPTION OF THE DRAWINGS

FIG. 1 is a block diagram illustrating a configuration of a dual-beam laser drilling system according to the present invention.

FIG. 2 is a view illustrating operation waveforms of a dual-beam laser drilling system according to the present invention.

FIG. 3 is a view illustrating the configuration and operation of a pulse controller in a dual-beam laser drilling system according to the present invention.

FIG. 4 is a view illustrating various embodiments of controlling and combining two laser pulses in a dual-beam laser drilling system according to the present invention.

### DETAILED DESCRIPTION

Hereinafter, embodiments of the present invention are described in detail with reference to the accompanying drawings.

The present invention is provided to more completely describe the present invention to those skilled in the art, and the following embodiments may be modified in various different forms, and the scope of the present invention is not limited to the following embodiments. Embodiments of the disclosure are provided to fully and thoroughly convey the spirit of the present invention to those skilled in the art.

As used herein, the thickness and size of each layer may be exaggerated for ease or clarity of description. The same reference denotations may be used to refer to the same or substantially the same elements throughout the specification and the drawings. As used herein, the term “A and/or B” encompasses any, or one or more combinations, of A and B. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

The terms as used herein are provided merely to describe some embodiments thereof, but not intended as limiting the present invention. As used herein, the singular forms “a,” “an,” and “the” are intended to include the plural forms as well, unless the context clearly indicates otherwise. As used herein, the term “comprise,” “include,” and/or “comprising” or “including” does not exclude the presence or addition of one or more other components, steps, operations, and/or elements than the component, step, operation, and/or element already mentioned.

As used herein, the terms “first” and “second” may be used to describe various members, parts, regions, areas, layers, and/or portions, but the members, parts, regions, areas, layers, and/or portions are not limited thereby. These terms are used merely to distinguish one member, part, region, area, layer, or portion from another. Accordingly, the term “first member,” “first part,” “first region,” “first area,” “first layer,” or “first portion” described herein may denote a “second member,” “second part,” “second region,” “second area,” “second layer,” or “second portion” without departing from the teachings disclosed herein.

The terms “beneath,” “below,” “lower,” “under,” “above,” “upper,” “on,” or other terms to indicate a position or location may be used for a better understanding of the relation between an element or feature and another as shown in the drawings. However, embodiments of the present invention are not limited thereby or thereto. For example, where a lower element or an element positioned under another element is overturned, then the element may be termed as an upper element or element positioned above the other element. Thus, the term “under” or “beneath” may encompass, in meaning, the term “above” or “over.”

As described herein, the controller and/or other related devices or parts may be implemented in hardware, firmware, application specific integrated circuits (ASICs), software, or a combination thereof. For example, the controller and/or other related devices or parts or its or their components may be implemented in a single integrated circuit (IC) chip or individually in multiple IC chips. Further, various components of the controller may be implemented on a flexible printed circuit board, in a tape carrier package, on a printed circuit board, or on the same substrate as the controller. Further, various components of the controller may be processes, threads, operations, instructions, or commands executed on one or more processors in one or more computing devices, which may execute computer programming instructions or commands to perform various functions described herein and interwork with other components. The computer programming instructions or commands may be stored in a memory to be executable on a computing device using a standard memory device, e.g., a random access memory (RAM). The computer programming instructions or commands may be stored in, e.g., a compact-disc read only memory (CD-ROM), flash drive, or other non-transitory computer readable media. It will be appreciated by one of ordinary skill in the art that various functions of the computing device may be combined together or into a single computing device or particular functions of a computing device may be distributed to one or other computing devices without departing from the scope of the present invention.

As an example, the controller of the present invention may be operated on a typical commercial computer including a central processing unit, a hard disk drive (HDD) or solid state drive (SSD) or other high-volume storage, a volatile memory device, a keyboard, mouse, or other input devices, and a monitor, printer, or other output devices.

The functions of a dual-beam laser drilling system according to the present invention are described as follows.

### [High-Speed Drilling]

A laser pulse emits continuous laser pulses having constant energy. This laser pulse is called a pulse train and is constituted of a series of pulses separated at temporally constant intervals.

These pulses are transmitted to a processing target through a beam steering device and are then physically spatially separated by a scanner moving at high speed. In other words, pulses are distributed while maintaining constant spacing in a processing area as the scanner moves.

Laser energy focused at high density causes perforation in a material at constant spacing. The size of perforation is determined by variables such as laser energy and pulse duration. Pulse duration and intensity are important factors that determine the depth, diameter, and quality of perforation.

A high-speed drilling system enables high-precision micro drilling by rapidly emitting such pulse trains. In this process, precise control of pulse spacing and energy is essential.

### [Signal Monitoring]

Signal monitoring plays a role of real-time identifying and adjusting synchronization between laser pulses and scanner position movement commands.

When laser beam on/off signals and pulse signals are transmitted asynchronously with scanner position movement commands, it becomes difficult to ensure repeatability of a position where a first spot is radiated and energy intensity. In other words, it becomes difficult to maintain accurate energy distribution at a first position each time a laser starts processing.

Further, in acceleration and deceleration sections of the scanner that occur at start and end points of processing lines, synchronization between laser pulses and scanner position does not match, making it difficult to maintain constant spacing between spots. In such asynchronous sections, focused energy becomes insufficient, and processing performance may deteriorate.

A system that monitors synchronization of laser signals, optical output signals, etc. in real-time using a high-speed signal processing system such as field-programmable gate array (FPGA) is necessary. Accordingly, a laser source, a scanner, and a controller share the same clock signal to achieve time-based synchronization.

Time-based synchronization causes all devices to operate according to the same time reference, so that precise timing of laser pulses and movement of the scanner match. Accordingly, position and energy of a laser exactly match during processing, and high-speed drilling operations are stably performed.

Through synchronization between scanner speed and repetition frequency of laser pulses, pulses may be accurately allocated per point even during high-speed movement to enable high-speed processing of hole patterns, energy coupling is maximized through temporal and spatial pulse overlap, progressive etching is achieved through repetition of multiple lines, process time required for large-area micro hole patterning is shortened, productivity is enhanced, and thermal deformation of materials is minimized.

The system according to the present invention uses a high-speed signal processing system to solve pulse spacing mismatch and synchronization problems due to scanner acceleration and deceleration that may occur in high-speed drilling. Accordingly, synchronization between precise timing of pulse trains and scanner position is maintained, ensuring consistent processing quality. Further, time-based synchronization utilizing FPGA, delay generators, master-slave triggering circuits, etc. matches precise control of laser pulses and position movement of the scanner, enabling high-speed and precise laser drilling.

### [Combining Multiple Lasers Having Different Wavelengths or Pulse Widths and High-Speed Steering]

The system according to the present invention is a system that coaxially combines a plurality of laser pulses having different characteristics from each other, i.e., having different laser wavelengths from each other or having different pulse widths (pulse duration) from each other, using a dichroic mirror, and performs precise and high-speed micro drilling on one synthesized spot by steering this at high speed through one scanner. In other words, by combining two or more lasers having different wavelengths or pulse widths and precisely steering them at high speed through high-speed steering devices (galvo, FSM, polygon scanner, etc.), repetitive and precise porous patterns may be formed by maintaining through holes having a constant size in high-strength metal layers at constant spacing.

The system according to the present invention may enhance etching efficiency and hole shape quality by spatially/temporally synthesizing and irradiating two laser beams having different laser wavelengths or pulse widths from each other. In this case, a laser pulse having a relatively long laser wavelength and a relatively large pulse width is mainly responsible for thermal penetration into an object and supplies heat or preheats the object. And a laser pulse having a short laser wavelength and small pulse width (femtosecond/picosecond/nanosecond laser pulse) is responsible for concentrating energy on a surface and wall surface, induces local ablation and shockwave to enhance absorption rate and penetration of long wavelength pulses while reducing hole entrance diameter and reducing taper to form holes with high aspect ratio, and contributes to enhancing circularity through increased internal reflection.

Meanwhile, the system according to the present invention may correct chromatic aberration and position deviation that occur when combining two lasers having different pulse widths or different laser wavelengths from each other, apply a correction angle using a fast steering mirror (FSM), etc., and implement precise spot synthesis by synchronizing a scanner and dual lasers based on FPGA/MCU.

Further, the system according to the present invention adopting multi-pulse lasers may form hole diameter small and uniform while enhancing circularity under the same total energy compared to using a single high-energy laser pulse. Further, when using a blue wavelength laser pulse having a short wavelength, plasma generation and debris generation may be suppressed, edge quality may be enhanced with less thermal effect compared to high output, and thereby cleaner holes may be formed.

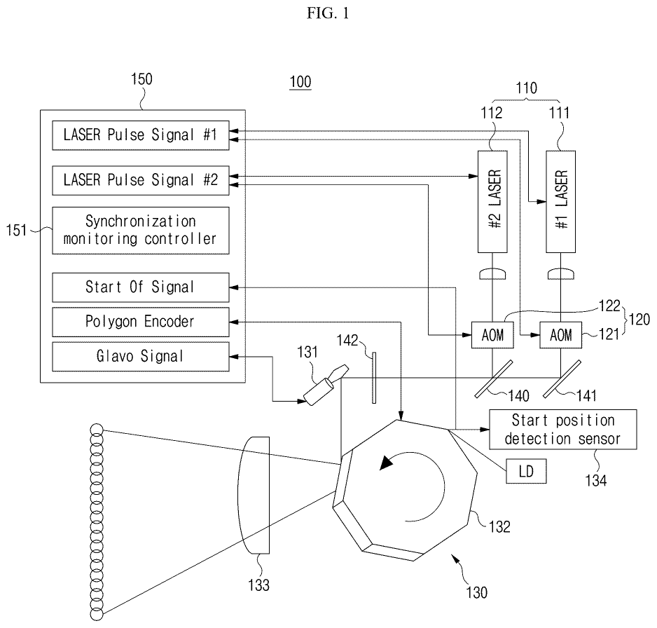

FIG. 1 is a block diagram illustrating a configuration of a dual-beam laser drilling system 100 according to the present invention. As illustrated in FIG. 1, a dual-beam laser drilling system 100 according to the present invention includes at least one of a laser source 110, a scanner 130, an optical coupling unit 140, and a controller 150, and may further include a pulse controller 120. The controller 150 may include a synchronization monitoring controller 151.

The laser source 110 is a device that generates laser pulses and plays an essential role in a drilling process. The laser source 110 used in the present invention may generate laser beams having various wavelengths and various pulse widths, thereby enabling high-speed, high-precision drilling for various types of materials.

The laser source 110 may generate laser beams of various wavelength ranges, and mainly used wavelengths are various from ultraviolet (UV) to near infrared (NIR), and general wavelengths may include 266 nm, 355 nm, 532 nm, and 1064 nm.

Each wavelength exhibits different physical characteristics for various materials. For example, a UV wavelength may process very small holes with high precision, and a NIR wavelength may mainly be used for metals and porous materials. By using various wavelengths, the laser source 110 may be flexibly applied to various types of processing.

The laser source 110 may vary at least one of output, pulse width (pulse width or pulse duration), and pulse repetition frequency (PRF), which is a function of adjusting average output of laser pulses, pulse duration, and frequency of occurrence. PRF is a factor that determines operation speed and processing precision of the laser source 110, and may perform fine and fast drilling by setting an optimal frequency for high-speed processing. Meanwhile, the laser source 110 may output laser pulses by determining only wavelength and basic output, and an acousto-optic modulator (AOM) or electro-optic modulator (EOM) to be described below may precisely adjust pulse width, pulse repetition frequency, intensity, timing, etc. by adjusting gating (on/off and timing) of laser pulses.

The laser source 110 may emit laser pulses of high energy level and may provide high pulse energy at kW and J levels. This high pulse energy is an essential element for high-speed processing, enabling a laser beam to efficiently remove materials by concentrating high-intensity energy.

The spot size of laser pulses is a size when a laser beam reaches a focal point, which is an important factor that determines precision of a laser. The spot size may be determined according to parameters such as λ (laser wavelength), M² (beam quality), f (focal length), and do (diameter of incident beam). The spot size may be calculated by the following formula:

$${d}_{f} = \frac{4 \cdot f \cdot λ \cdot {M}^{2}}{{d}_{0} \cdot π}$$

Where:
λ: laser wavelength
M²: beam quality coefficient, which affects beam concentration
f: focal length, which is the distance to focal point of laser beam
d₀: diameter of incident beam

The spot size d_{f} has an important effect on processing quality, and focal length and incident beam diameter play decisive roles. The smaller the spot size, the higher the processing precision, enabling accurate processing of fine holes at high speed.

As such, the laser source 110 generates high-power laser pulses at constant periods, and the spacing may be adjusted according to PRF. These pulses may be concentrated on rapidly processed materials to form fine holes.

Further, the laser source 110 may be precisely controlled to match movement speed of the scanner 130 each time a pulse is generated. As the scanner 130 moves at high speed, laser pulses occur periodically at constant spacing to realize uniform processing.

The laser source 110 emits laser pulses having high energy and enables high-speed drilling in connection to the scanner 130. Further, intensity of laser pulses is adjusted to match materials being processed, providing energy optimized for each material.

In one or more embodiments, the laser source 110 may include a first laser source 111 for outputting a first laser pulse and a second laser source 112 for outputting a second laser pulse.

Here, the first laser pulse and the second laser pulse have different characteristics from each other. Different characteristics mean that the first laser pulse and the second laser pulse have different laser wavelengths from each other or have different pulse widths from each other.

The first laser pulse and the second laser pulse may have different wavelengths from each other but may have the same pulse width. In such a case, the controller 150 controls such that each pulse of the first laser pulse and the second laser pulse completely matches each other on the same time axis.

Meanwhile, the first laser pulse and the second laser pulse may have different pulse widths from each other. In this case, wavelengths of the first laser pulse and the second laser pulse may be the same or different from each other. When wavelengths or pulse widths are different from each other, it is preferable that wavelength and pulse width of the first laser pulse are shorter or smaller than wavelength and pulse width of the second laser pulse.

When pulse widths of the two laser pulses are different, the controller 150 may control such that each pulse of the first laser pulse is disposed within each pulse width of the second laser pulse. In this case, the controller 150 may control such that one or more each pulse of the first laser pulse is disposed within each pulse width of the second laser pulse.

Each laser source may output a laser pulse having a small pulse width (femtosecond/picosecond/nanosecond pulse), or may output a rectangular laser pulse having a large pulse width or a continuous wave (CW) type laser beam.

Wavelength or pulse width (pulse duration) that the first laser pulse and the second laser pulse have is only relative and may vary. Among a plurality of lasers, a laser having a short pulse duration (e.g., femtosecond, picosecond, nanosecond laser) induces local initial micro damage (micro ablation) on a processing surface, thereby significantly enhancing absorptivity of a laser having a long pulse duration (e.g., millisecond or CW laser) that is radiated thereafter. Accordingly, even under the same average output or total energy, more activated melting, vaporization, and high heat transfer effects by multiple reflections (internal reflection) are implemented, enabling deeper and more precise drilling.

The pulse controller 120 performs a role of adjusting each of on/off gating and timing of the first laser pulse and the second laser pulse. The pulse controller 120 is controlled by the controller 150 and may control to dispose a plurality of pulses of the first laser pulse within each pulse of the second laser pulse or dispose pulse widths of the first and second laser pulses to completely match each other.

The pulse controller 120 may control laser pulses or laser beams at high speed by utilizing acousto-optic modulator (AOM) or electro-optic modulator (EOM) optical components. The pulse controller 120 modulates laser beams and thereby may control at least one of pulse width, intensity, and pulse repetition frequency at high speed by controlling gating (on/off and timing) of laser pulses, and may also control or adjust beam path at high speed using beam deflection according to diffraction.

The pulse controller 120 may include an optical medium, an ultrasonic generator, and a dump structure. The optical medium may include a crystal or semiconductor, through which modulation occurs as a laser beam passes. An ultrasonic signal is transferred through this optical medium, whereby a path of a laser beam may be diffracted. The ultrasonic generator may convert an electrical signal into ultrasonic waves and transfer to the optical medium. This ultrasonic wave propagates through the optical medium and may periodically change a refractive index of a laser beam. Accordingly, a path of a beam changes and characteristics of laser pulses may be adjusted. The dump structure is a structure for dissipating this beam after a 0th beam (0th beam) occurs. In AOM, a 0th beam is a beam that is transmitted as is without being diffracted by ultrasonic waves. This beam is dissipated in a dump structure and emitted to the outside, thereby effectively removing unnecessary beam energy.

AOM having such a structure operates through interaction between ultrasonic waves and laser beams. AOM may adjust gating, duration, and pulse repetition frequency of pulses while maintaining wavelength of laser pulses as is. Main operation processes are as follows:

In AOM, ultrasonic waves may propagate through an optical medium. These ultrasonic waves periodically change a laser beam path and diffract a laser beam through this.

A path that a laser beam moves by being diffracted changes according to ultrasonic frequency. This diffracted laser beam becomes a 1st beam (1st beam). On the other hand, a beam that progresses as is without being affected by ultrasonic waves becomes a 0th beam (0th beam), and this beam progresses as is.

Pulse length control in AOM is achieved by adjusting ultrasonic signals. By adjusting amplitude or frequency of ultrasonic waves, duration of laser pulses may be finely adjusted. Accordingly, laser pulses may be controlled at high speed and laser beams may be emitted only for necessary time.

This pulse control function may be importantly used particularly in high-speed laser processing and high-precision micro processing. By precisely controlling length of laser pulses, processing quality may be enhanced and unnecessary excessive processing may be prevented.

A diffraction phenomenon occurring in AOM transforms a path of a laser beam according to frequency of ultrasonic waves. A diffracted beam becomes a 1st beam (1st beam) and changes direction. On the other hand, a laser beam that is not diffracted is transmitted as a 0th beam (0th beam) and progresses.

This 0th beam may remain unnecessarily, so it is dissipated and removed using a dump structure. This process enables efficient energy management and precise beam control.

The dump structure plays a role of dissipating a 0th beam and effectively emits unnecessary beam energy to the outside to increase efficiency of a laser system.

The dump structure plays a role of emitting heat generated when a 0th beam comes out from the laser source 110, thereby contributing to temperature management and stability securing of the system.

As such, using AOM may only adjust length of laser pulses. Frequency of a laser is maintained as is, whereby length of pulses may be finely adjusted while leaving other characteristics of the laser (intensity, wavelength, etc.) as is.

Further, since AOM may rapidly control ultrasonic signals, laser pulses may be controlled at high speed. This characteristic plays a very important role in high-speed processing and precise drilling operations.

Pulse control using AOM enables fine adjustment during laser processing, making it suitable for precise micro drilling and high-precision processing. Accordingly, processing quality is enhanced and unnecessary excessive processing or thermal damage may be prevented.

AOM may effectively process unnecessary energy through a dump structure that dissipates a 0th beam, contributing to enhancing efficiency and stability of the system.

Therefore, AOM is a device that controls laser pulses at high speed and may precisely adjust length and intensity of laser pulses. Use of AOM may realize high-speed, high-precision processing and may be very usefully utilized in various industrial fields. High-speed pulse control using AOM is a technology that greatly enhances performance of laser processing systems and may be applied to various fields such as precise micro drilling, surface processing, and substrate manufacturing.

In one or more embodiments, the pulse controller 120 may include a first pulse controller 121 coupled to the first laser source 111 and a second pulse controller 122 coupled to the second laser source 112. Such a pulse controller 120 is described again below.

The optical coupling unit 140 is a beam combiner that performs a role of coaxially combining a plurality of laser pulses having different wavelengths or pulse widths from each other, and may be implemented as a dichroic mirror that coaxially combines a first laser pulse and a second laser pulse.

In one or more embodiments, the optical coupling unit 140 may further include at least one of a fast steering mirror (FSM) 141 and a deformable mirror 142.

The fast steering mirror (FSM) 141 may be interposed between the first pulse controller 121 and the optical coupling unit 140, and the deformable mirror 142 may be interposed between the optical coupling unit 140 and the scanner 130.

The fast steering mirror 141 performs a role of correcting position deviation due to aberration by high-speed steering of a first laser pulse and is controlled by the controller 150. If high-speed steering of a first laser pulse is not necessary, a general mirror may be used instead of the fast steering mirror 141.

Further, the fast steering mirror 141 may be controlled such that the first laser pulse moves in a specific path within a beam of the second laser pulse. In other words, the fast steering mirror 141 may cause a first laser pulse to move in rotational, vibrational, and spiral paths within a beam of a second laser pulse having a relatively large diameter. The fast steering mirror 141 is controlled by the controller 150, and the controller 150 may set a scan pattern or drilling trajectory of a first laser pulse.

The deformable mirror 142 may adjust an overall optical focus in real-time in a state in which a first pulse laser and a second pulse laser are coaxially synthesized. In order to correct effects such as focus deviation, wall reflection loss, and plasma shielding that occur as drilling depth increases, a focus position is progressively moved downward according to order of repetitive irradiation. As a Z-axis focus is moved downward stepwise by deformation of the deformable mirror 142 according to drilling processing time or processing depth, an aspect ratio of processing holes may be enhanced and minimization of entrance diameter may be implemented. In other words, real-time focus adjustment of an entire optical system is possible as the deformable mirror 142 is deformed according to a control signal of the controller 150. In addition to a deformable mirror, a fast tunable lens, a piezo stage, a vibration stage, etc. may also be applied.

The scanner 130 is a device that steers a laser beam to a desired position and includes at least one of a Galvano motor 131, a polygon mirror 132, and a focus lens 133, and may further include a protection window or plate.

The Galvano motor 131 is a motor that rotates a mirror and may rapidly steer at minute angles. The Galvano motor 131 provides high precision and enables miniaturization with few space constraints. Usually, two Galvano motors 131 are used to control a laser beam in X and Y axes.

The polygon mirror 132 has a polyhedral structure and enables high-speed linear scanning to move a laser beam at high speed. The polygon mirror 132 provides higher processing speed compared to the Galvano scanner 130, but may have constraints in path flexibility. For example, the polygon mirror 132 has limited range of angle adjustment and operates advantageously mainly in constant patterns.

The focus lens 133 is a device that helps concentrate a laser beam to a very small area. This plays an important role in high-precision micro drilling, surface processing, etc., and adjusts focus size and energy density of a laser beam. This lens supports precise laser processing.

A protection window or plate plays a role of preventing contamination by scattered particles rising from a lower chamber of the scanner 130. It protects sensitive components of the scanner 130 from being damaged by dust or contaminants generated during processing and contributes to enhancing durability of the system.

The scanner 130 having such a configuration plays a role of rapidly and accurately moving a laser beam to deliver the beam precisely to a position suitable for a processing target.

To that end, first, the Galvano motor 131 steers a laser beam in X and Y axes. Each motor may move a laser beam to a desired position through minute angle adjustment.

Next, the polygon mirror 132, i.e., a polyhedral mirror, rotates at high speed to linearly move a laser beam rapidly. The polygon mirror 132 may rapidly deliver beams by rapidly rotating multiple surfaces.

The focus lens 133 collects a laser beam to a focal point and may accurately deliver to a processing area. This concentrates energy of a laser in a very small area, enabling high-precision micro drilling.

Focal length of a lens has a great effect on accuracy of laser processing and may control size and intensity of a laser beam.

Meanwhile, a protection window or plate plays a role of blocking dust or scattered particles that may occur during processing. Accordingly, the inside of the scanner 130 is protected from contamination and equipment life is extended.

Further, using the polygon mirror 132, a laser beam may move through rapid linear scanning. This method enables processing at very high speed to enhance productivity. However, since the polygon mirror 132 is advantageous only in constant patterns, there may be limitations in path flexibility.

Further, the scanner 130 has an important effect on position accuracy of pulse beams. The higher the position accuracy, the more accurately a laser beam reaches a processing target, and constant spacing between holes may be maintained and fine patterns may be accurately formed.

The performance of the scanner 130 affects overall processing speed and flexibility. For example, the polygon mirror 132 enables high-speed linear scanning compared to a Galvano scanner but may have constraints in path flexibility. This may give specific limitations to processing patterns or movement paths of laser beams.

On the other hand, the Galvano motor 131 has excellent flexibility and may precisely steer laser beams along various paths. However, speed may be relatively low compared to the polygon mirror 132.

The scanner 130 may be used in various application fields such as high-speed micro drilling, precision processing, and surface treatment. Since processing speed and precision are determined according to performance of the scanner 130, this technology is particularly important in fuel cell manufacturing, porous metal filters, the electronic device substrate processing, etc. Further, it is essential in industries requiring precise pattern formation or high-speed drilling during laser processing.

The scanner 130 is an important device in a laser drilling system 100 and may accurately and rapidly move a laser beam to deliver to a desired position. The performance of the scanner 130 has a great effect on processing quality and speed, and the Galvano motor 131 and polygon mirror 132 are methods having respective advantages and disadvantages and may be used in combination with each other. Further, the focus lens 133 and protection window perform precise processing and equipment protection.

The controller 150 controls a first laser pulse and a second laser pulse having different characteristics from each other in synchronization.

In this case, when the pulse widths of the first and second laser pulses are the same, the controller 150 may control such that each pulse of the first laser pulse and second laser pulse completely matches on the same time axis.

Meanwhile, when the pulse widths of the first and second laser pulses are different (in this case, wavelengths of the first and second laser pulses may be the same or different from each other), the controller 150 may control such that one or more each pulse of the first laser pulse is disposed within each pulse width of the second laser pulse. In this case, the controller 150 may control such that a start point of each pulse of the first laser pulse is disposed at a preset specific point of each pulse of the second laser pulse and, when disposing a plurality of first laser pulses, may control such that output intensity of the first laser pulse gradually increases during each pulse duration of the second laser pulse.

The controller 150 integrally controls the laser source 110, pulse controller 120, scanner 130, and optical coupling unit 140, and may maintain synchronization of a first pulse laser and second pulse laser in real-time, detect errors, and automatically correct through the synchronization monitoring controller 151.

The synchronization monitoring controller 151 may ensure precise synchronization between time intervals of laser pulses and rotation speed of the scanner 130. The synchronization monitoring controller 151 monitors a laser beam emitted from a laser processing device and ensures that spacing between pulses is maintained constantly. The synchronization monitoring controller 151 may include at least one of a pulse train, a pulse energy meter, a beam splitter, and a photodiode (PD) sensor.

Meanwhile, although not illustrated in the drawing, the controller 150 may further include a processing monitoring controller.

The processing monitoring controller controls an inline monitoring device such as inline coherence imaging (ICI). A representative optical coherence tomography (OCT) system among ICI devices includes an optical coherence tomography unit (OCT unit), an OCT scanner, an OCT source, and a transmission fiber. The OCT source may be selected from swept source OCT (SS-OCT) or spectral domain OCT (SD-OCT), and axial resolution is determined according to center wavelength (e.g., 840 nm or 1310 nm) and bandwidth (e.g., 50-100 nm).

The OCT source is combined with a processing laser through a fixed beam splitter or dichroic mirror in a coaxial path and is focused on a sample through a common focusing lens. An OCT measurement beam is co-scanned with a processing laser or independently steered by an auxiliary scanner, enabling monitoring without parallax at the same position. On the other hand, since an OCT laser shares a scanner of a processing laser, it has a scanner independent of the scanner of the processing laser for position correction due to aberration and independent position control.

OCT analyzes reflection signals from processing surface and inside in an interference form to extract information about processing depth, hole shape, melting status, material boundary layer, plasma shielding, etc. in real-time. An OCT signal is transmitted to a controller (Control Unit or Signal Processor) to perform feedback control of the following processing processes.

End-point detection: cutting off laser output or ending processing when target depth is reached. Focus tracking: real-time adjustment of focus position (Z-axis) according to perforation progress. Power adjustment: automatic adjustment of pulse energy or average output according to material absorption change. Abnormal condition alarm: processing interruption or warning generation when abnormal reflection or thermal damage is detected. Scan position correction: correction of error between scanner coordinates and actual processing position. Such control is performed in real-time through signal linkage between an OCT controller and laser controller, enhancing processing precision and reliability of the entire system.

A pulse train is a method of emitting continuous laser pulses from the laser source 110. In this case, time intervals between pulses are factors that determine spacing between holes. If pulse intervals are maintained constantly, spacing between processed holes may also be formed uniformly.

A pulse energy meter allows the synchronization monitoring controller 151 to measure pulse energy of individual laser pulses in real-time to identify whether each pulse is being emitted with constant energy. This is because energy of laser pulses should be constant to maintain uniform processing quality.

A beam splitter allows a portion of a laser beam to be transferred to the synchronization monitoring controller 151. A beam splitter divides a laser beam to accurately monitor synchronization state through polarization, wavelength, peak power filtering, etc. A partial transmission mirror or beam splitter may be used to divide a portion of a laser beam for monitoring.

A PD sensor receives a divided laser beam and converts to current. This sensor detects signals of laser pulses and may convert to electrical signals and transfer to the synchronization monitoring controller 151. In one or more embodiments, the PD sensor may include a high-speed amplifier, an integrator, and an analog-to-digital converter (ADC). A high-speed amplifier amplifies signals generated in the PD sensor and converts to processable signals. An integrator integrates signals received at high speed to monitor average values or signal changes over time. An ADC converts analog signals to digital signals so that the controller 150 may process.

As such, the synchronization monitoring controller 151 receives a portion of laser beams from the laser source 110 and scanner 130 respectively to synchronize rotation speed of the scanner 130 and spacing of laser pulses. If spacing of laser pulses is maintained constantly, processing that exactly matches movement of the scanner 130 is achieved. Accordingly, uniform spacing between holes may be implemented.

The synchronization monitoring controller 151 monitors timing of laser pulses and movement of the scanner 130 in real-time to ensure precise synchronization and may operate as follows.

The synchronization monitoring controller 151 first monitors pulse spacing. Laser pulses generated through a pulse train should occur at constant time intervals, and in this case, since spacing between pulses determines spacing between holes, it is important to maintain precise time intervals. The synchronization monitoring controller 151 may monitor such spacing between pulses in real-time and control to maintain constant spacing.

Next, the synchronization monitoring controller 151 measures pulse energy. The pulse energy of laser pulses should be constant for processing quality to be maintained uniformly. The synchronization monitoring controller 151 divides a portion of a laser beam emitted from a laser processing device, measures pulse energy through the PD sensor, and identifies whether there is no energy fluctuation.

Next, the synchronization monitoring controller 151 performs beam division and signal processing. A portion of a laser beam may be transferred to the synchronization monitoring controller 151 through a partial transmission mirror or beam splitter. This beam is divided according to characteristics such as polarization or wavelength, and through this, precise position and timing of laser pulses are monitored.

Next, the synchronization monitoring controller 151 performs signal processing of the PD sensor. The PD sensor receives a portion of a beam and converts to electrical signals. This signal is amplified by a high-speed amplifier, then processed as an average signal through an integrator, and may be digitized through an ADC.

The converted signal is transferred to the controller 150 implemented as FPGA or MCU to maintain precise synchronization between rotation speed of the scanner 130 and laser pulses.

Finally, the synchronization monitoring controller 151 compares and adjusts synchronization between laser pulses and position and rotation speed of the scanner 130 in real-time. Accordingly, laser pulses are fired exactly to match position of the scanner 130, and constant spacing between holes is maintained.

Such synchronization monitoring controller 151 precisely synchronizes spacing between laser pulses and movement speed of the scanner 130 to ensure uniform spacing between holes. This enables high-speed and high-precision processing. Further, the synchronization monitoring controller 151 monitors spacing and energy between pulses in real-time and automatically corrects when problems occur. Accordingly, processing quality may be consistently maintained. The synchronization monitoring controller 151 may be usefully used in various fields such as high-speed micro drilling, precision processing, surface treatment, and fuel cell manufacturing. Precise synchronization enhances laser processing quality and enables efficient production.

As such, the synchronization monitoring controller 151 processes timing of laser pulses and position synchronization of the scanner 130 in real-time to enable high-speed laser processing. Through such synchronization monitoring controller 151, uniformity of processing quality is maintained and contributes to enhancing precision in high-speed drilling operations.

As described above, the controller 150 may integrally control core elements of the system such as the laser source 110, pulse controller 120, optical coupling unit 140 (particularly the fast steering mirror 141 and deformable mirror 142), scanner 130, and synchronization monitoring controller 151.

First, the controller 150 may control output of the laser source 110. In one or more embodiments, a user sets laser output, pulse period, intensity, etc. through a laser setting window. This setting is transferred to the controller 150, and the controller 150 sends a control signal to the pulse controller 120. The optical controller 120 may control on/off state of laser pulses to activate or deactivate a laser according to a given pattern. Through this process, pulses generated from the laser source 110 are emitted at precise timing.

The controller 150 may control operation of the pulse controller 120 (i.e., AOM/EOM). The pulse controller 120 plays a role of precisely controlling pulses generated from the laser source 110 and may selectively emit or block laser pulses according to signals transmitted from the controller 150, and may also adjust pulse width, pulse repetition frequency, intensity, and beam path of laser pulses. Generation period, pulse width, and timing of laser pulses are precisely adjusted by the pulse controller 120, and through this, speed and position of laser pulses may be precisely controlled.

The controller 150 may control speed and movement path of the scanner 130. The scanner 130 is a device that steers a laser beam to a desired position, sets rotation speed of the polygon mirror 132, and receives a scan start signal (SOS) that detects a time when the polygon mirror 132 rotates from the start position detection sensor 134 and adjusts this. This SOS signal is transferred to the controller 150 and enables synchronization between rotation of the polygon mirror 132 and laser pulses.

The controller 150 synchronizes movement of laser pulses and the scanner 130 through the synchronization monitoring controller 151. A polygon encoder signal and SOS signal track position and state of the scanner 130 in real-time, and based on this data, transmit precise control signals to the pulse controller 120 so that laser pulses are emitted at precise times.

Further, the synchronization monitoring controller 151 monitors energy of laser pulses in real-time and detects state of beams through PD sensors to maintain consistency of the system. This system ensures synchronization between high-speed rotation of the scanner 130 and position and size of laser beams so that high-speed precise processing may be achieved.

The controller 150 may perform calculations at every clock of the system through high-speed I/O and control all signals in real-time. Accordingly, movement of laser beams and polygon scanner 130 is precisely synchronized, and timing of laser pulses is precisely matched so that laser processing may be achieved.

Further, the controller 150 transmits all control signals so that each component is synchronized at precise times and manages the entire system to operate smoothly. The core of this system is to compare and adjust timing of laser pulses, position movement of the scanner 130, and synchronization state in real-time. Accordingly, spacing between laser pulses and movement speed of the scanner 130 are matched to maintain constant spacing between holes, enabling high-speed precision processing.

Further, the controller 150 may control the fast steering mirror 141 to steer a first laser pulse at high speed, whereby a spot of a first laser pulse may be moved within a spot diameter of a second laser pulse having a relatively large diameter.

Further, the controller 150 may control the deformable mirror 142 to dynamically vary an overall optical focus of coaxially synthesized laser beams. In order to respond to focus shift, wall reflection/absorption, and plasma shielding that occur according to drilling duration or drilling processing depth, by moving an overall focus position of coaxially synthesized laser pulses downward stepwise according to processing time or processing depth, aspect ratio may be enhanced and minimization of entrance diameter may be implemented.

As such, the controller 150 precisely controls each element of the system such as the laser source 110, pulse controller 120, fast steering mirror 141, deformable mirror 142, scanner 130, and synchronization monitoring controller 151, and through this, plays a role of implementing high-speed and high-precision micro drilling. The role of the controller 150 is to monitor and control the system in real-time to maintain consistent quality and enable efficient operation.

Meanwhile, the controller 150 transmits two laser pulse signals (Laser Pulse Signal #1, Laser Pulse Signal #2) to two laser sources 111 and 112 respectively. Such signals control laser pulses emitted from laser sources 111 and 112 and may be controlled through respective pulse controllers 121 and 122. Each pulse determines timing and intensity emitted from laser sources 111 and 112, and on/off state may be controlled through pulse controllers 121 and 122 such as AOM or EOM.

Further, the controller 150 receives start of signal (SOS) from the start position detection sensor 134, receives a polygon encoder signal from a polygon encoder, and receives a Galvano signal from the Galvano motor 131 respectively.

SOS is a signal that detects start of rotation of a polygon scanner 130. It detects a moment when each reflecting surface of the polygon mirror 132 changes to cause the scanner 130 to start processing. A polygon encoder signal is a signal that monitors position of the polygon mirror 132 in real-time. This signal plays a role of ensuring that the scanner 130 accurately reaches processing points. A Galvano signal is a signal generated from the Galvano motor 131 and may control precise movement of laser beams. This signal helps laser beams move precisely in X and Y-axis directions.

Each pulse controller 121 and 122 may be used to control laser pulses. The pulse controllers 121 and 122 selectively control pulses to on/off state, and two pulse controllers 121 and 122 may be used to precisely control generation of laser pulses.

As described above, the start position detection sensor 134 detects position of the polygon mirror 132 and helps a laser start processing precisely at a start position.

As described above, the polygon mirror 132 is a polyhedral mirror that enables high-speed linear scanning. Due to rapid rotation of a mirror, a laser beam moves at high speed, enabling rapid and precise drilling operations through this.

As such, the controller 150 inputs control signals to pulse controllers 121 and 122 to adjust laser pulses. This signal may be used to precisely match spacing and timing of laser pulses.

As such, the system 100 according to the present invention matches precise timing and position of laser pulses and controls speed and direction of the scanner 130 to realize precise processing. Each component is synchronized in real-time to maintain processing quality and enable precise drilling of holes at constant spacing.

Further, the system 100 according to the present invention utilizes dual-beam laser technology to simultaneously adjust two laser pulses and enable high-speed precise drilling. Accordingly, rapid and precise laser processing becomes possible in various industrial fields.

In one or more embodiments, a dual-beam laser drilling system 100 may use a first laser source 111 and second laser source 112 together. This is to optimize characteristics and advantages of each laser to realize more efficient and precise processing for various materials. Since each laser pulse has different wavelength characteristics, suitable lasers may be selected according to specific circumstances or requirements to enhance processing quality.

An IR laser (infrared laser) is a laser having a longer wavelength (long wavelength) than visible light (e.g., 1064 nm). An IR laser may be well absorbed by materials such as metals or porous metals. Since it illustrates high absorption rates particularly in materials such as metals, it is advantageous for high-speed cutting and drilling. An IR laser may concentrate high energy in a narrow space to minimize thermal damage and perform precise processing. It is ideal for cutting metals or drilling holes.

A blue laser has a short wavelength (short wavelength) belonging to a visible light range (e.g., 445 nm). A blue laser absorbs energy more efficiently in non-metallic materials, plastics, ceramics, etc. It illustrates higher absorption rates in non-metallic materials compared to IR lasers. Since a blue laser having a short wavelength may be focused at high density, it is suitable for forming fine patterns or high-precision processing. Further, it exhibits excellent performance in surface treatment or pattern formation. A blue laser has shallow processing depth for specific materials and is fast, reducing thermal effects. It is effective for thin materials or sensitive surfaces.

The reason for using lasers of different wavelengths in a dual-beam system 100 is to enable processing optimized for materials suitable for characteristics of each laser. IR lasers and blue lasers each exhibit excellent performance in different materials. Accordingly, metals and non-metals may be processed simultaneously, which is advantageous for processing various materials.

Using two lasers together may handle various processing operations more rapidly and efficiently. For example, metals may be processed with IR lasers and plastics or ceramics may be processed with blue lasers to obtain optimized results.

Since blue lasers provide smaller focus sizes, they are advantageous for fine patterns or high-precision operations. On the other hand, IR lasers are advantageous for drilling deep holes with high output, so using two lasers together may enhance processing quality.

The reason for using long wavelength IR lasers and short wavelength blue lasers together in a dual-beam laser system 100 is to exhibit optimal performance for various materials and realize precise processing and efficient operations. IR lasers have strengths in metal processing, and blue lasers show advantageous characteristics in non-metals and high-precision operations. Therefore, broader and more precise laser processing is possible using two lasers simultaneously.

A blue laser as a first laser pulse and an IR laser as a second laser pulse are merely exemplary and are not limited thereto, and lasers of various wavelengths may be used. The first laser pulse may have a relatively short wavelength compared to the second laser pulse, and the second laser pulse may have a relatively longer wavelength than a first laser pulse.

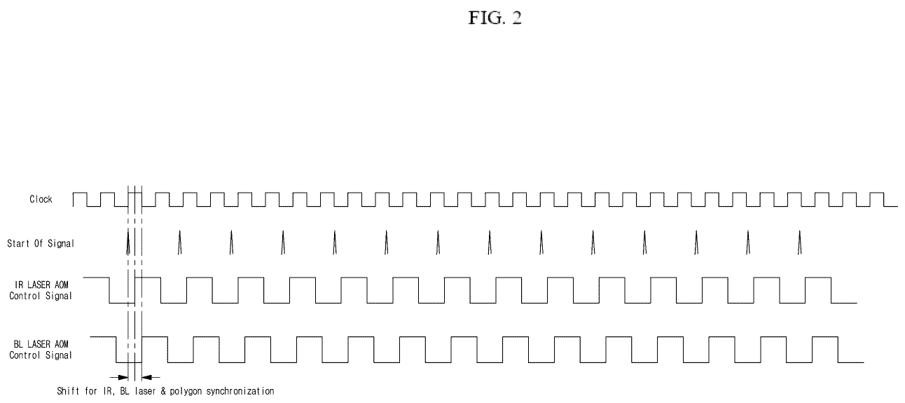

FIG. 2 is a view illustrating operation waveforms of a dual-beam laser drilling system 100 according to the present invention. According to FIG. 2, waveform diagrams of a clock signal, a start of signal, an IR laser AOM control signal, and a BL laser AOM control signal may be seen. The diagram describes synchronization and shift between IR laser, BL laser, and polygon mirror.

IR laser and BL laser are two types of lasers having different wavelengths from each other. The reason for using these two lasers simultaneously is that each laser exhibits optimal performance for different types of materials.

IR laser is effective for metals and materials having high thermal conductivity, and BL laser illustrates excellent performance in non-metallic materials or high-precision operations. Rapid and efficient processing may be performed for various materials using these two lasers simultaneously.

The polygon mirror 132 is a polyhedral mirror that reflects laser beams at constant angles while rotating. This mirror rotates at high speed and plays a role of scanning laser beams. As may be seen in the diagram, rotation speed of the polygon mirror 132 and timing of laser pulses should be synchronized.

Rotation of the polygon mirror 132 may be detected by a start of scan (SOS) signal. This signal indicates a moment when each reflecting surface of the polygon mirror 132 changes, and causes laser pulses to occur at precise timing based on this time.

A polygon encoder signal and SOS signal inform precise position and rotation timing of a mirror and play important roles in synchronizing laser pulses and position of the scanner 130.

IR laser and BL laser have different wavelengths from each other. Each laser should be activated at different times, and shift is used to precisely match this time.

Shift is a method of synchronizing generation timing of laser pulses and adjusts so that pulses of each laser precisely mesh with scan positions.

In one or more embodiments, an IR laser fires pulses with a slight time difference from a blue laser. This shift is synchronized with rotation state of the polygon mirror 132 and may be adjusted so that pulses of two lasers do not overlap each other.

In this case, if pulse spacing of IR laser and BL laser does not match well, processing paths of two lasers may not match or processing quality may deteriorate.

While the polygon mirror 132 rotates, each reflecting surface should reflect laser beams to match specific positions, and laser pulses should be fired at that time.

IR laser and BL laser are fired at different timings, and pulse trains of each laser should be synchronized.

To that end, shift is used to adjust so that pulses of each laser may be fired at precisely matching positions. This time difference should match rotation of the polygon mirror 132, so each reflecting surface of a mirror should be able to reflect laser pulses at precise times.

Shift maintains synchronization of the system. Through this synchronization, IR laser and BL laser may maintain consistent processing quality despite different wavelengths. Further, precise time differences between the polygon mirror 132 and laser pulses may be adjusted to fire laser pulses at precise positions. If synchronization is not well achieved in the system according to the present invention, spacing between perforations may become irregular or processing quality may deteriorate.

As such, in the present invention, IR laser and BL laser are used to exhibit optimal performance in different materials respectively, and pulses may be synchronized to precisely match through shift between two lasers. Synchronization between the polygon mirror 132 and laser pulses is combined with this shift to precisely deliver laser beams to precise positions in high-speed drilling operations. Accordingly, rapid and precise processing may be performed for various materials.

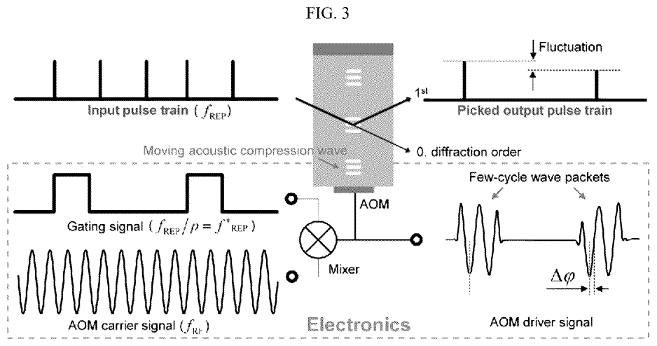

FIG. 3 is a view illustrating configuration and operation of a pulse controller 120 in a dual-beam laser drilling system 100 according to the present invention. As described above, the pulse controller 120 may mean an acousto-optic modulator (AOM), and operation is described using a diagram.

An input pulse train f_{REP} is a set of pulses separated at constant time intervals. These pulses are input to the laser source 110 and occur constantly according to a repetition rate f_{REP} of pulses.

AOM may control laser pulses using moving acoustic compression waves. AOM selectively turns laser pulses on/off and selectively emits pulses to generate diffraction.

In AOM, 0th diffraction order represents a case where an original laser beam progresses as is, and 1st diffraction order is a result of a laser beam being diffracted by ultrasonic waves.

A gating signal (f_{REP}/ρ=f_{REP}) is a signal that controls AOM and plays a role of selectively emitting or blocking laser pulses. This signal may be used to control pulse trains.

Meanwhile, an AOM carrier signal f_{RF} is a basic frequency signal on which AOM operates. This signal generates ultrasonic compression waves, and through this, level changes and pulse control are possible.

Further, a mixer combines a gating signal and AOM carrier signal to generate a driver signal. This signal is directly transmitted to AOM to control selective emission of pulses.

Further, an AOM driver signal affects output of AOM to adjust time intervals and energy distribution between pulses.

Few-cycle wave packets generated in this process optimize quality of laser pulses by adjusting pulse period and phase difference (Δφ).

Finally, an output pulse train may include only pulses selected from an input pulse train. This output pulse train is delivered to a laser processing system at precise timing, and processing is achieved in a state in which spacing and energy between pulses are controlled.

Fluctuation represents variation that may occur in output signals, and this variation may occur when a system is not properly synchronized or laser control is inaccurate.

In summary, in the pulse controller 120, an input pulse train is laser pulses occurring at constant intervals, and AOM plays a role of selectively emitting or blocking laser pulses. A gating signal and AOM carrier signal are signals that control timing of laser pulses, and a mixer combines these signals to generate an AOM driver signal and adjusts laser pulses through this. An output pulse train represents finally controlled laser pulses, and through this, precise laser processing is possible.

Such pulse controller 120 may precisely control time intervals and energy distribution of laser pulses to provide uniform processing quality and precise timing during laser processing. High-speed, high-precision laser processing is realized through selective emission and blocking of pulses through AOM.

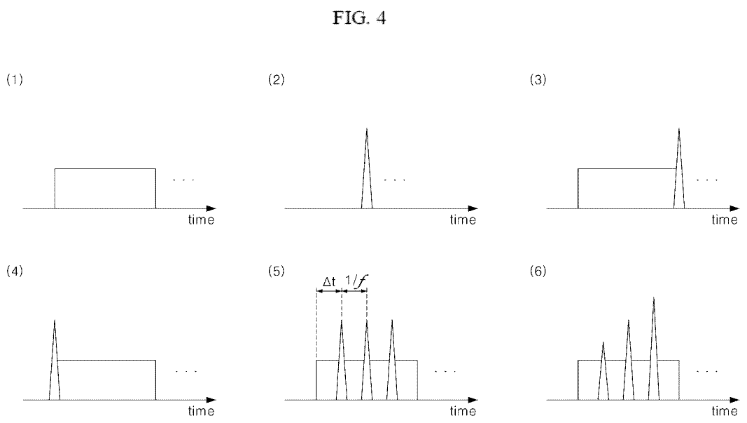

FIG. 4 is a view illustrating various embodiments of controlling and combining two laser pulses in a dual-beam laser drilling system 100 according to the present invention.

Referring to FIG. 4, a controller 150 of a dual-beam laser drilling system 100 according to the present invention may coaxially combine a plurality of laser pulses having different wavelengths and pulse widths from each other in various ways.

In the example of FIG. 4, an impulse type laser pulse is exemplified as having a short pulse width and a rectangular type laser pulse is exemplified as having a long pulse width, but this is merely an example and is not limited thereto. Both laser pulses may be impulse type or rectangular type, of course. Meanwhile, when pulse widths of two laser pulses are the same, each pulse of two laser pulses only needs to be completely matched on the same time axis, so corresponding drawings and descriptions are omitted.

(1) exemplifies a rectangular second laser pulse having a relatively long wavelength and large pulse width, and (2) exemplifies a first laser pulse having a relatively short wavelength and small pulse width.

In FIG. 4, (3) is an embodiment of controlling timing of first and second laser pulses so that a first laser pulse is disposed near a time when each pulse of the second laser pulse turns off, and (4) is an embodiment of controlling timing of first and second laser pulses so that a first laser pulse is disposed near a time when a pulse of the second laser pulse turns on.

Further, a controller 150 of a dual-beam laser drilling system 100 according to the present invention may control so that n (n≥1) first laser pulses are output during each pulse duration of the second laser pulse as in (5). Of course, Δt, which is a time difference between a first laser pulse and second laser pulse, is maintained constantly throughout an entire pulse train section.

In (3) to (5), points where each pulse of a first laser pulse is disposed are merely exemplary, and the controller 150 may control so that a start point of each pulse of a first laser pulse is disposed at a preset specific point of each pulse of the second laser pulse, of course.

Further, a controller 150 of a dual-beam laser drilling system 100 according to the present invention may control so that n pulses of a first laser pulse are output during each pulse duration of the second laser pulse as in (6), but may control so that output intensity of a first laser pulse gradually increases (gradual ramp-in). Temporal power modulation of laser output may prevent material deformation, cracking, or plasma shielding phenomenon due to excessive thermal pressure at a start stage of perforation, and may suppress thermal stress relief and pore crack generation.

What has been described above is only one embodiment for implementing a dual-beam laser drilling system according to the present invention, and the present invention is not limited to the above-described embodiment, and as claimed in the following claims, anyone with ordinary knowledge in the field to which the present invention belongs may make various modifications without departing from the gist of the present invention, and the technical spirit of the present invention extends to a range where such modifications are possible.

What is claimed is:

1. A dual-beam laser drilling system comprising:
a first laser source outputting a first laser pulse;
a second laser source outputting a second laser pulse;
an optical coupling unit coaxially combining the first laser pulse and the second laser pulse;
a scanner for drilling by irradiating the coaxially combined laser beam to a processing target; and
a controller controlling the first laser pulse and the second laser pulse in synchronization, wherein the first laser pulse and the second laser pulse have different characteristics from each other.

2. The dual-beam laser drilling system of claim 1, wherein the first laser pulse and the second laser pulse have different pulse widths from each other, and wherein the controller controls such that each pulse of the first laser pulse is disposed within each pulse width of the second laser pulse.

3. The dual-beam laser drilling system of claim 1, wherein the first laser pulse and the second laser pulse have different wavelengths from each other but have the same pulse width, and wherein the controller controls such that each pulse of the first laser pulse and the second laser pulse completely matches on the same time axis.

4. The dual-beam laser drilling system of claim 1, further comprising a pulse controller adjusting each of on/off gating and timing of the first laser pulse and the second laser pulse, and wherein the controller controls the pulse controller to dispose a plurality of pulses of the first laser pulse within each pulse of the second laser pulse or to dispose such that pulse widths completely match.

5. The dual-beam laser drilling system of claim 4, wherein the pulse controller includes a first pulse controller and a second pulse controller adjusting each of on/off gating and timing of the first laser pulse and the second laser pulse under the control of the controller, and wherein the first pulse controller and the second pulse controller include an acousto-optic modulator (AOM) or an electro-optic modulator (EOM) for performing optical modulation.

6. The dual-beam laser drilling system of claim 1, wherein the scanner includes a Galvano motor, a start position detection sensor, and a polygon mirror, and wherein the start position detection sensor detects a laser beam reflected from the polygon mirror to detect a start position of the polygon mirror and transmits to the controller.

7. The dual-beam laser drilling system of claim 1, wherein the controller includes a synchronization monitoring controller for synchronizing timing of the first laser pulse and the second laser pulse with position movement of the scanner in real-time.

8. The dual-beam laser drilling system of claim 1, wherein the optical coupling unit further includes a deformable mirror for adjusting an overall optical focus of the coaxially combined laser beam, and wherein the controller controls to move an optical Z-axis focus downward stepwise according to a drilling processing time or processing depth.

9. The dual-beam laser drilling system of claim 1, wherein the optical coupling unit further includes a fast steering mirror for high-speed steering of the first laser pulse, and wherein the controller controls the fast steering mirror to correct position deviation due to aberration.

10. The dual-beam laser drilling system of claim 9, wherein the controller controls the fast steering mirror such that the first laser pulse moves in a specific path within a beam of the second laser pulse.

11. The dual-beam laser drilling system of claim 2, wherein the controller controls such that a start point of each pulse of the first laser pulse is disposed at a specific point of each pulse of the second laser pulse.

12. The dual-beam laser drilling system of claim 11, wherein the controller controls such that a plurality of pulses of the first laser pulse are disposed within each pulse width of the second laser pulse.

13. The dual-beam laser drilling system of claim 12, wherein the controller controls such that an output intensity of the first laser pulse gradually increases during each pulse duration of the second laser pulse.
